(19) United States
(12) Patent Application Publication
(10) Pub. No.: US 2017/0075129 A1
(43) Pub. Date: Mar. 16, 2017

(54) Anti-Shake Lens Driving Device

(71) Applicant: PowerGate Optical Inc., Zhubei City (TW)

(72) Inventors: Wen Tsai Hsu, Zhubei City (TW); Ying Chun Huang, Zhubei City (TW); Chuan Yu Hsu, Zhubei City (TW)

(73) Assignee: PowerGate Optical Inc., Zhubei City (TW)

(21) Appl. No.: 15/263,656

(22) Filed: Sep. 13, 2016

(30) Foreign Application Priority Data
Sep. 15, 2015 (TW) 104214927

(51) Int. Cl. G02B 27/64; G02B 7/04; G03B 13/36; G03B 5/02

(52) U.S. Cl. CPC G02B 27/646; G03B 5/02; G02B 7/04; G03B 13/36; G03B 2205/0023; G03B 2205/0046

(57) ABSTRACT

An anti-shake lens driving device includes a cover, a base, a movable part, a spring member, four upper magnets, four lower magnets, four driving coils and a circuit board. The cover has a through hole. The base is sleeved by the cover to form a central accommodation room. The movable part performs image-capturing through the through hole. The spring member is mounted exteriorly to the movable part to elastically fix the movable part inside the accommodation room. The upper magnets located above the spring member circle evenly the movable part. The lower magnets located below the spring member in a one-to-one matching manner with respect to the upper magnets circle evenly the movable part. The driving coils positioned individually corresponding to the upper/lower magnets circle evenly the movable part in a rectangle formation. The circuit board includes a circuit loop and electrically couples the driving coils.

This application claims the benefit of Taiwan Patent Application Serial No. 104214927, filed Sep. 15, 2015, the subject matter of which is incorporated herein by reference.

### BACKGROUND OF INVENTION

1. Field of the Invention

The invention relates to an anti-shake lens driving device, and more particularly to the anti-shake lens driving device that is designed for improving deviations of a lens module caused by unexpected shakes in zooming and/or focusing.

2. Description of the Prior Art

Digital photography technology has been widely applied to most of the portable electronic devices such as the cellular phones. Various miniaturized techniques in the lens module are involved to make all these applications possible; in particular, the voice coil motor (VCM) technique. The VCM introduces a combination of coiled magnets and spring plates to drive a lens to move back and forth along a photo axis for image-capturing, so as to perform auto-zooming and/or auto-focusing of the lens module. Further, in this trend of devices capable of high-level photographing functions, photographic quality and various camera functions are also demanded; such as thousand pixels, anti-hand shake ability and so on.

In an optical system composed of a lens module and an image-compensation module, such as a camera system or a video recorder system, hand shake or some external situations usually occur to bias the optical path so as to degrade the imaging upon the image-compensation module and further to obscure the formation of the images. A conventional resort to resolve this problem is to introduce a further compensation mechanism for overcoming possible shaking during the imaging. Such a compensation mechanism can be either digital or optical.

In the art, the digital compensation mechanism is to analyze and process the digital imaging data capturing by the image-compensation module, so as to obtain a clearer digital image. Such a mechanism is also usually called as a digital anti-shake mechanism. On the other hand, the optical compensation mechanism, usually called as an optical anti-shake mechanism, is to add a shake-compensation module upon the lens module or the image-compensation module. Currently, most of the optical anti-shake mechanisms in the market (for example, the Hall sensor for detecting lens' bias and the like) are consisted of plenty complicated or cumbersome components and thus are usually complicatedly structured, difficultly assembled, expensive, and hard to be further miniaturized. Obviously, a further improvement upon such the anti-shake mechanism is definitely necessary.

### SUMMARY OF THE INVENTION

Accordingly, it is the primary object of the present invention to provide an anti-shake lens driving device that can correct tilt angles of a lens module so as to avoid ill imaging caused by unexpected shakes, and further to prevent cost hike from using the Hall sensor in the anti-shake lens driving device.

It is another object of the present invention to provide an anti-shake lens driving device that an exterior spring member is used to mount a movable part (lens carrier) at a middle place thereof so as to control electromagnetic forcing to perform continuous zooming/focusing of the movable part (lens carrier).

In the present invention, the anti-shake lens driving device is defined with an X axis, a Y axis and a Z axis, perpendicular to each other, and includes a cover, a base, a movable part, a spring member, four upper magnets, four lower magnets, four driving coils, a circuit board and a housing.

The cover has a through hole. The base engages the cover by having the cover to sleeve over the base so as to form a central accommodation room in between. The movable part defined with an optical image-capturing axis parallel to the Z axis is to capture images through the through hole. The spring member mounted exteriorly to circle the movable part at a middle portion thereof is to elastically fix the movable part inside the accommodation room. The four upper magnets, evenly circling the movable part, are located above the spring member. The four lower magnets, also evenly circling the movable part, are located below the spring member in a one-to-one matching manner with respect to the upper magnets. The four driving coils are positioned individually in correspondence with the four pairs of the upper/lower magnets, and evenly circle the movable part in a rectangle formation. The circuit board includes a circuit loop, and electrically couples the four driving coils. The movable part includes a lens carrier and a lens. The lens, located on the optical image-capturing axis, is mounted inside the lens carrier.

By having the circuit board to control the currents, either the magnitudes or the directions, of the four driving coils so as to perform the correction controls of the tilt angles through the four pairs of the upper/lower magnets located exteriorly to the movable part that is elastically mounted by the spring member. Thereupon, ill imaging caused by unexpected shakes can be avoided. In addition, by inputting currents to control the four driving coils, the four pairs of the corresponding upper/lower magnets can be indirectly controlled to drive the movable part, which is restrained elastically by the spring member, to perform elastic Z-axial movement inside the accommodation room. Namely, by controlling the input currents, the movable part can perform continuous zooming and/or focusing.

All these objects are achieved by the anti-shake lens driving device described below.

### BRIEF DESCRIPTION OF THE DRAWINGS

The present invention will now be specified with reference to its preferred embodiment illustrated in the drawings, in which:

FIG. 1 is a schematic exploded view of a first embodiment of the anti-shake lens driving device in accordance with the present invention;

FIG. 2 is a schematic perspective view of FIG. 1, in an assembly formation;

FIG. 3A is a top view of FIG. 2;

FIG. 3B is a schematic cross-sectional view of FIG. 3A along line A-A;

FIG. 4 shows schematically a circuit loop for the first embodiment of the anti-shake lens driving device in accordance with the present invention;

FIG. 5 is a schematic exploded view of a second embodiment of the anti-shake lens driving device in accordance with the present invention;

FIG. 6 is a schematic perspective view of FIG. 5, in an assembly formation;

FIG. 7A is a top view of FIG. 6;

FIG. 7B is a schematic cross-sectional view of FIG. 7A along line B-B;

FIG. 8 shows schematically a circuit loop for the second embodiment of the anti-shake lens driving device in accordance with the present invention;

FIG. 9 is a schematic exploded view of a third embodiment of the anti-shake lens driving device in accordance with the present invention;

FIG. 10 is a schematic perspective view of FIG. 9, in an assembly formation;

FIG. 11A is a top view of FIG. 10;

FIG. 11B is a schematic cross-sectional view of FIG. 11A along line C-C; and

FIG. 12 shows schematically a circuit loop for the third embodiment of the anti-shake lens driving device in accordance with the present invention.

### DESCRIPTION OF THE PREFERRED EMBODIMENT

The invention disclosed herein is directed to an anti-shake lens driving device. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

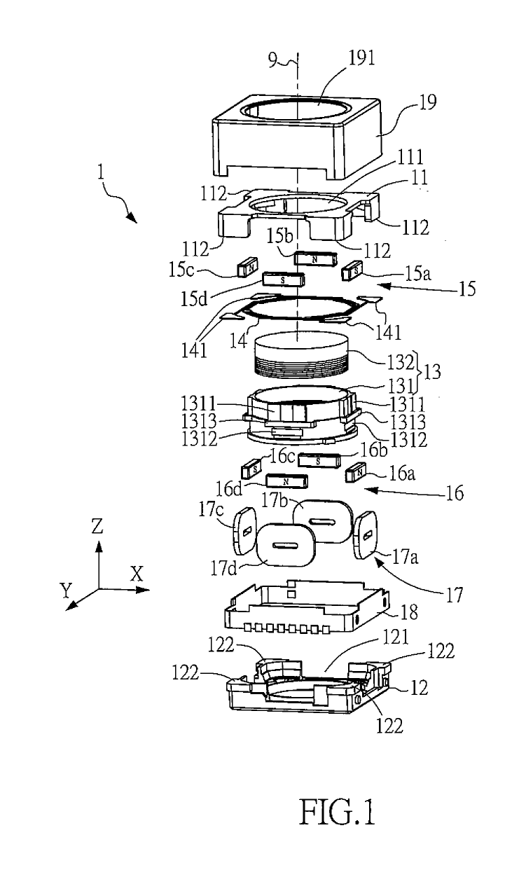

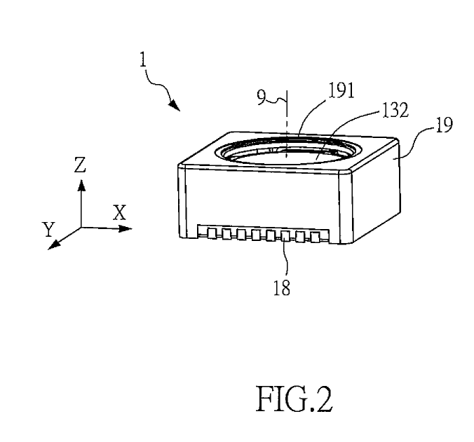

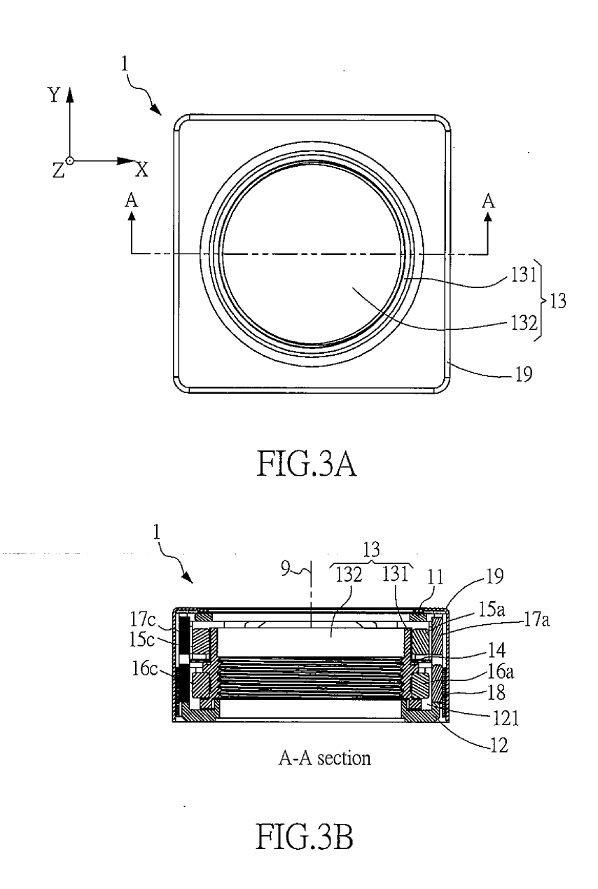

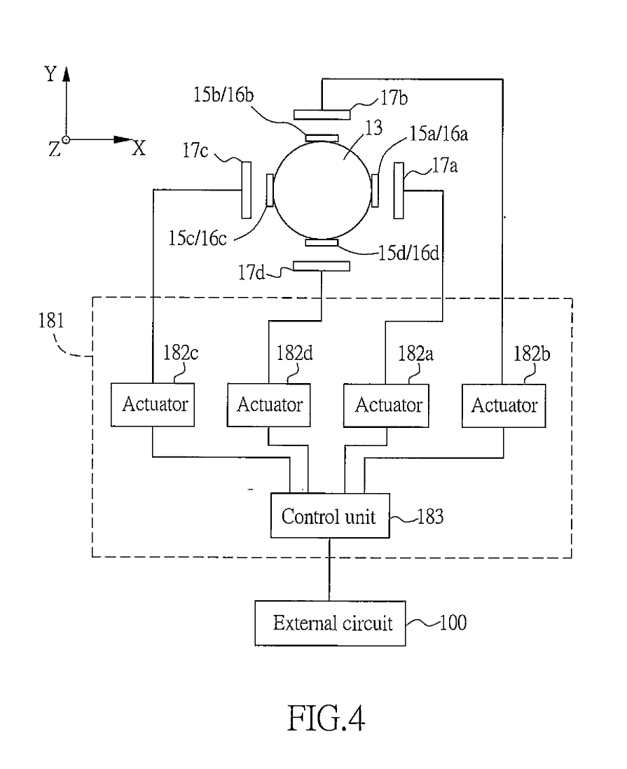

Refer now to FIG. 1, FIG. 2, FIG. 3A, FIG. 3B and FIG. 4; where FIG. 1 is a schematic exploded view of a first embodiment of the anti-shake lens driving device in accordance with the present invention, FIG. 2 is a schematic perspective view of FIG. 1 in an assembly formation, FIG. 3A is a top view of FIG. 2, FIG. 3B is a schematic cross-sectional view of FIG. 3A along line A-A, and FIG. 4 shows schematically a circuit loop for the first embodiment of the anti-shake lens driving device in accordance with the present invention.

In this first embodiment, the anti-shake lens driving device 1 is defined with an orthogonal X-Y-Z coordinate system having an X axis, a Y axis and a Z axis, perpendicular to each other. Also, the anti-shake lens driving device 1, formed in an open-loop mode, includes a cover 11, a base 12, a movable part 13, a spring member 14, four upper magnets 15 (15a˜15d), four lower magnets 16 (16a˜16d), four driving coils 17 (17a˜17d), a circuit board 18, and a housing 19.

The cover 11 has a central through hole 111 and four engagement ends 112 located individually at four corner of the cover 11. The cover 11 is to engage the base 12 in a sleeving-over manner so as to form an accommodation room 121 in between thereof. In particular, the base 12 is formed as a square frame having four corners to construct four corresponding fixation ends 122 for engaging the four respective engagement ends 112 of the cover 11 with the spring member 14 to be fixedly sandwiched in between.

The spring member 14, made of a metallic material, is shaped to be an elastic thin-plate body with middle empty spaces, and can be manufactured by a mechanical stamping/punching process or a chemical etching process. The spring member 14 has a circular rim protruding outward four isolated spring fixing ends 141, and each of the spring fixing ends 141 is clamped in between by a corresponding engagement pair of the fixation end 122 of the base 12 and the respective engagement end 112 of the cover 11. Thereupon, the movable part 13 can be elastically positioned in the accommodation room 121 by sleeving the spring member 14.

The movable part 13, defined with an optical image-capturing axis 9 parallel to the Z axis, is to capture images along the optical image-capturing axis 9 that penetrates the through hole 111. The movable part 13 includes a lens carrier 131 and a lens 132. The lens 132 is located on the optical image-capturing axis 9 and inside the lens carrier 131. Exterior to the lens carrier 131, there includes four upper fixing structures 1311, four lower fixing structures 1312, and at least one fixation lip 1313 (four in this embodiment). The four upper fixing structures 1311, positioned in correspondence to the four lower fixing structures 1312, are located circularly to the exterior of the lens carrier 131 for anchoring the upper magnets 15 (15a˜15d) and the lower magnets 16 (16a˜16d). In addition, the fixation lips 1313 are used to mount the spring member 14 exterior to the lens carrier 131.

In this first embodiment, these four fixation lips 1313, located individually between the corresponding upper fixing structures 1311 and the corresponding lower fixing structures 1312, are to further fix the spring member 14 exterior to the movable part 13, such that the lens carrier 131 can be elastically located inside the accommodation room 121 via the spring member 14.

The four upper magnets 15 (15a˜15d) are located evenly to circle the exterior of the movable part 13, and positioned above the spring member 14. In addition, these four lower magnets 16 (16a˜16d) are located evenly to circle the exterior of the movable part 13, and positioned below the spring member 14 at locations individually corresponding to the upper magnets 15 (15a˜15d). Further, the upper magnets 15 (15a˜15d) are mounted individually to the corresponding upper fixing structures 1311, while the lower magnets 16 (16a˜16d) are mounted individually corresponding to the lower fixing structures 1312. In each pair of the upper magnet 15 (15a˜15d) and the lower magnet 16 (16a˜16d), polarities of the upper magnet 15 (15a˜15d) and the corresponding lower magnet 16 (16a˜16d) are different (i.e. N/S or S/N). In addition, two neighboring upper magnets 15(15a˜15d) or two neighboring lower magnets 16(16a˜16d) have different polarities (i.e. N/S or S/N).

As stated above, these four driving coils 17 (17a˜17d) are located at positions individually corresponding to the respective upper/lower magnets 15a/16a˜15d/16d, and are evenly arranged into four sides of a rectangle enclosing the movable part 13. The circuit board 18 further enclosing these four driving coils 17 (17a˜17d) includes a circuit loop 181 and couples electrically each of the four driving coils 17 (17a˜17d). The housing 19 having a central bore 191 is to shell the cover 11 and the base 12 by allowing the central bore 191 to align with the through hole 111 with respect to the same optical image-capturing axis 9. In the present invention, the optical image-capturing axis 9 is parallel to the Z axis.

Namely, as shown in FIG. 1, the four upper magnets 15(15a˜15d) are to pair the four lower magnets 16 (16a˜16d), where the upper and lower magnets 15a, 16a and the corresponding upper and lower magnets 15c, 16c at the opposite side are all located on the X axis. Thus, these four magnets 15a, 16a, 15c and 16c are designed to correct tilt angular deviation in the X axial direction, and controlled electromagnetically by the two corresponding the driving coils 17a, 17c. On the other hand, the neighboring pair of the upper and lower magnets 15b, 16b and the opposite pair of the upper and lower magnets 15d, 16d are both located on the Y axis. Thus, these four magnets 15b, 16b, 15d and 16d are designed to correct tilt angular deviation in the Y axial direction, and controlled electromagnetically by the two corresponding the driving coils 17b, 17d.

As shown in FIG. 4, the circuit loop 181 for the first embodiment of the anti-shake lens driving device further includes four actuators 182 (182a˜182d) and a control unit 183. These four actuators 182 (182a˜182d) connect individually to the four driving coils 17 (17a˜17d), and then electrically couple the control unit 183. Through the control unit 183, the four actuators 182 (182a˜182d) can manipulate the four pairs of the upper and lower magnets 15a/16a˜15d/16d via the four corresponding driving coils 17 (17a˜17d), so as to correct the tilt angles in the X and Y axial directions, respectively, or the displacement of the movable part 13 in the Z axial direction.

Namely, the circuit loop 181 of the circuit board 18 can utilize an external circuit 100 to couple electrically the control unit 183, and thereby to control current scales and directions at the four driving coils 17 (17a˜17d), so as further to perform the correction controls of the tilt angles through the four pairs of the upper/lower magnets 15a/16a˜15d/16d located exteriorly to the movable part 13 that is elastically mounted by the spring member 14. Thereupon, ill imaging caused by unexpected shakes can be avoided. In the present invention, the external circuit 100 can be one of a mobile phone, a tablet computer, a notebook computer and the like external circuit.

In addition, by inputting specific current scales and directions to control the four driving coils 17 (17a˜17d), the four pairs of the corresponding upper/lower magnets 15a/16a˜15d/16d can be indirectly controlled to drive the movable part 13, restrained elastically by the spring member 14, to perform elastic Z-axial movement inside the accommodation room 121. Namely, with the elasticity provided by the spring member 14, the lens carrier 131 inside the accommodation room 121 can displacement back and forth within a predetermined distance along the optical image-capturing axis 9 (i.e. the Z axial direction. In addition, by controlling the input current, continuous zooming/focusing of the lens 132 can be performed.

More specifically, if a tilt angular deviation of the movable part 13 on the X axis exists, the magnets in charge of the X-axial correction, i.e. the upper and lower magnets 15a, 16a and the upper and lower magnets 15c, 16c on the opposite side, can utilize the two corresponding driving coils 17a, 17c to input currents to the respective actuators 182a, 182c, so as to perform corrections of the tilt angle in the X axial direction upon the lens carrier 131. Thereupon, the object of the present invention in compensating the X-axial deviations caused by unexpected shake can be achieved. On the other hand, if a tilt angular deviation of the movable part 13 on the Y axis exists, the magnets in charge of the Y-axial correction, i.e. the upper and lower magnets 15b, 16b and the upper and lower magnets 15d, 16d on the opposite side, can utilize the two corresponding driving coils 17b, 17d to input currents to the respective actuators 182b, 182d, so as to perform corrections of the tilt angle in the Y axial direction upon the lens carrier 131. Thereupon, the object of the present invention in compensating the Y-axial deviations caused by unexpected shake can be achieved. Of course, the tilt angular deviations on the X axis and the Y axis can be corrected simultaneously by using the control unit 183, through the four actuators 182 (182a˜182d), to control the four driving coils 17 (17a˜17d) at the same time. Thereby, the correction upon the X-axial and Y-axial tilt angular deviations can be performed at the same time. Also, continuous back-and-forth displacements of the movable part 13 in the Z axial direction for performing continuous zooming and/or focusing can be achieved.

In the following descriptions upon the other embodiments of the present invention, since most of elements in the following embodiments are the same or similar to the preceding embodiment, thus explanations for the same elements would be omitted herein. Also, the same elements will apply the same numbers and the names. To those similar elements, though the same names are given, yet a tailing letter would be added to the same number for a distinguishing purpose, but explanations for those similar elements are also omitted herein.

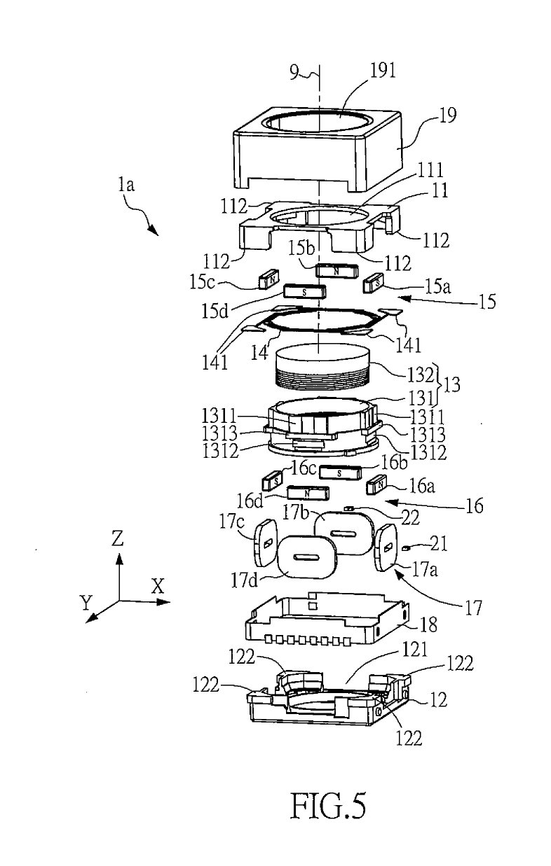

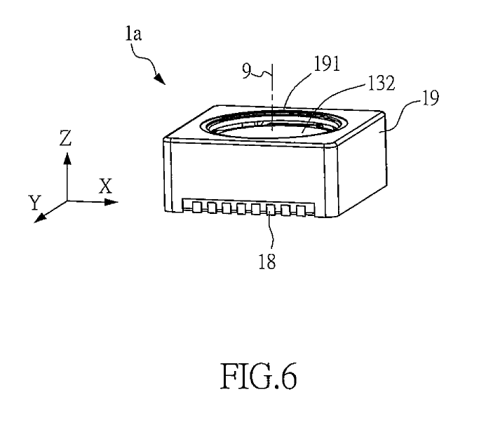

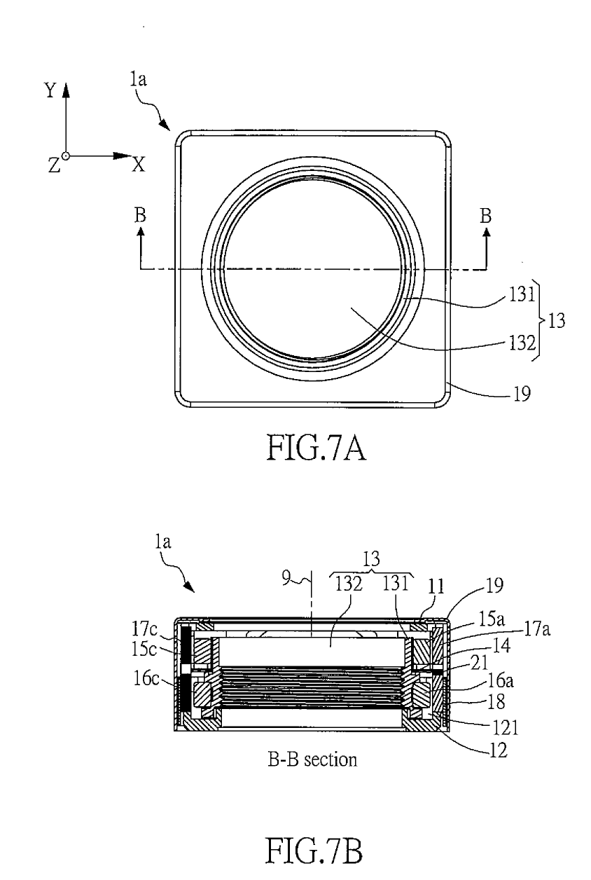

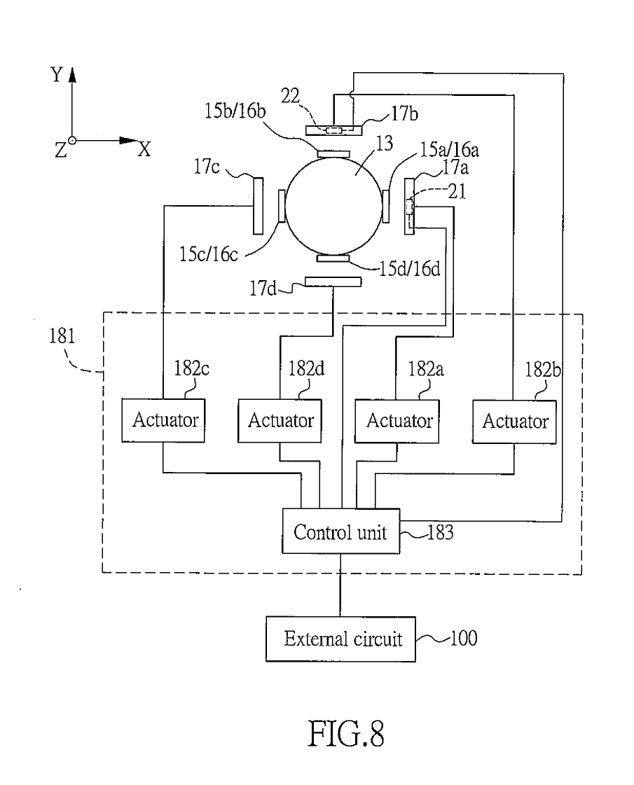

Refer now to FIG. 5, FIG. 6, FIG. 7A, FIG. 7B and FIG. 8; where FIG. 5 is a schematic exploded view of a second embodiment of the anti-shake lens driving device in accordance with the present invention, FIG. 6 is a schematic perspective view of FIG. 5 in an assembly formation, FIG. 7A is a top view of FIG. 6, FIG. 7B is a schematic cross-sectional view of FIG. 7A along line B-B, and FIG. 8 shows schematically a circuit loop for the second embodiment of the anti-shake lens driving device in accordance with the present invention.

In the second embodiment, the major difference between this second embodiment and the preceding first embodiment is that, in this second embodiment, the anti-shake lens driving device 1a as a close loop mode I further includes a first sensor 21 and a second sensor 22. The first sensor 21 is mounted to one of the driving coils 17 (17a˜17d). In particular, the first sensor 21 is located in the central empty space of the driving coil 17a, and electrically coupled with the control unit 183 of the circuit loop 181. The second sensor 22 is located in the central empty space of another driving coil 17b, and electrically coupled with the control unit 183 of the circuit loop 181. The second sensor 22 is neighbored by the first sensor 21. In this second embodiment, the first sensor 21 is an X-axial tilt-angle detector, while the second sensor 22 is a Y-axial tilt-angle detector. In addition, the first and second sensors 21, 22 can be further used to detect the Z-axial position of the movable part 13.

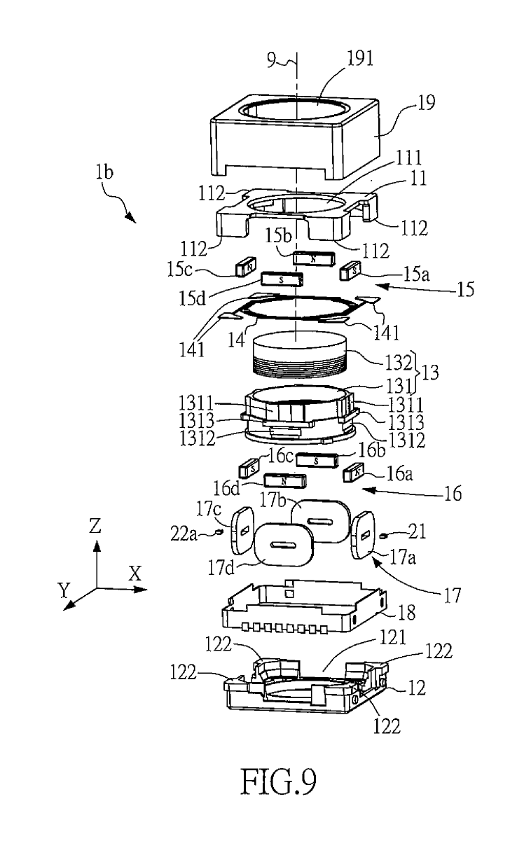

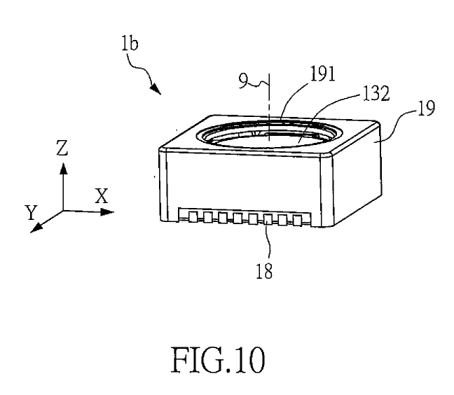

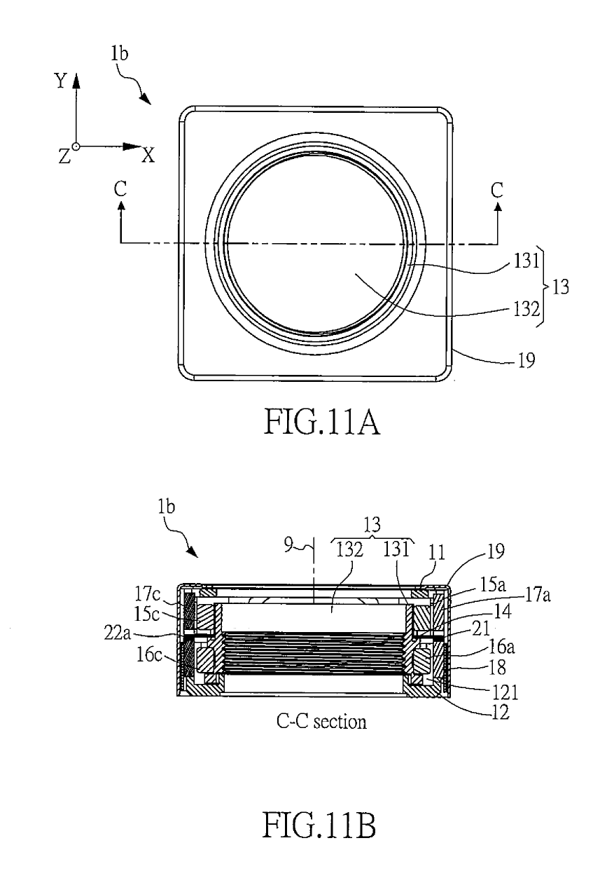

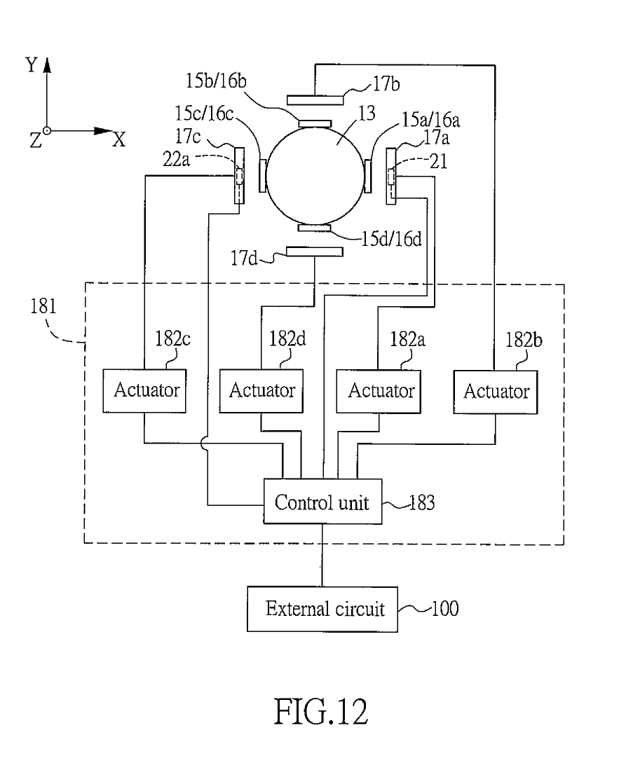

Refer now to FIG. 9, FIG. 10, FIG. 11A, FIG. 11B and FIG. 12; where FIG. 9 is a schematic exploded view of a third embodiment of the anti-shake lens driving device in accordance with the present invention, FIG. 10 is a schematic perspective view of FIG. 9 in an assembly formation, FIG. 11A is a top view of FIG. 10, FIG. 11B is a schematic cross-sectional view of FIG. 11A along line C-C, and FIG. 12 shows schematically a circuit loop for the third embodiment of the anti-shake lens driving device in accordance with the present invention.

In the third embodiment, the major difference between this third embodiment and the preceding second embodiment is that, in this third embodiment, the anti-shake lens driving device 1b is a close loop mode II. The second sensor 22a is located in the central empty space of the driving coil 17c, electrically coupled with the control unit 183 of the circuit loop 181, and positioned at a place opposing to the first sensor 21. Similarly, the first and second sensors 21, 22a are able to detect the Z-axial position of the movable part 13.

In summary, the anti-shake lens driving device 1 of the present invention is defined with an X axis, a Y axis and a Z axis, perpendicular to each other, and includes a cover 11, a base 12, a movable part 13, a spring member 14, four upper magnets 15 (15a˜15d), four lower magnets 16 (16a˜16d), four driving coils 17 (17a˜17d), a circuit board 18 and a housing 19.

The cover 11 has a through hole 111. The base 12 engages the cover 11 by having the cover 11 to sleeve over the base 12 so as to form a central accommodation room 121 in between. The movable part 13 defined with an optical image-capturing axis 9 parallel to the Z axis is to capture images through the through hole 111. The spring member 14 mounted exteriorly to circle the movable part 13 at a middle portion thereof is to elastically fix the movable part 13 inside the accommodation room 121. The four upper magnets 15 (15a˜15d), evenly circling the movable part 13, are located above the spring member 14. The four lower magnets 16 (16a˜16d), also evenly circling the movable part 13, are located below the spring member 14 in a one-to-one matching manner with respect to the upper magnets 15 (15a˜15d). The four driving coils 17 (17a˜17d) are positioned individually in correspondence with the four pairs of the upper/lower magnets 15a/16a˜15d/16d, and evenly circles the movable part 13 in a rectangle formation. The circuit board 18 includes a circuit loop 181, and electrically couples the four driving coils 17 (17a˜17d).

The housing 19 having a central bore 191 shells the cover 11 and the base 12 by allowing the central bore 191 to align the through hole 111 along the same optical image-capturing axis 9, which is parallel to the Z axis. The movable part 13 includes a lens carrier 131 and a lens 132. The lens 132, located on the optical image-capturing axis 9, is mounted inside the lens carrier 131.

By having the circuit board 18 to control the currents, either the magnitudes or the directions, of the four driving coils 17 (17a˜17d) so as to perform the correction controls of the tilt angles through the four pairs of the upper/lower magnets 15a/16a˜15d/16d located exteriorly to the movable part 13 that is elastically mounted by the spring member 14. Thereupon, ill imaging caused by unexpected shakes can be avoided. In addition, by inputting currents to control the four driving coils 17(17a˜17d), the four pairs of the corresponding upper/lower magnets 15a/16a˜15d/16d can be indirectly controlled to drive the movable part 13, which is restrained elastically by the spring member 14, to perform elastic Z-axial movement inside the accommodation room 121. Namely, by controlling the input currents, the movable part 13 can perform continuous zooming and/or focusing.

While the present invention has been particularly shown and described with reference to a preferred embodiment, it will be understood by those skilled in the art that various changes in form and detail may be without departing from the spirit and scope of the present invention.

What is claimed is:

1. An anti-shake lens driving device, defined with an X axis, a Y axis and a Z axis, perpendicular to each other, comprising:
a cover, having a through hole;
a base, engaging the cover by having the cover to sleeve over the base so as to form a central accommodation room;
a movable part, defined with an optical image-capturing axis parallel to the Z axis, performing image-capturing through the through hole;
a spring member, mounted exteriorly to circle the movable part at a middle portion thereof so as to elastically fix the movable part inside the accommodation room;
four upper magnets, evenly circling the movable part and being located above the spring member;
four lower magnets, evenly circling the movable part and being located below the spring member in a one-to-one matching manner with respect to the four upper magnets;
four driving coils, positioned individually in correspondence with the upper/lower magnets and evenly circling the movable part in a rectangle formation; and
a circuit board, including a circuit loop and electrically coupling the four driving coils.

2. The anti-shake lens driving device of claim 1, wherein the movable part further includes a lens carrier and a lens, the lens being located on the optical image-capturing axis and inside the lens carrier.

3. The anti-shake lens driving device of claim 1, further including a housing having a central bore, the housing shelling the cover and the base so as to have the central bore to align the through hole with respect to the same optical image-capturing axis.

4. The anti-shake lens driving device of claim 1, wherein polarities of the upper magnets and the corresponding lower magnets are different, and also two neighboring upper magnets or two neighboring lower magnets have different polarities.

5. The anti-shake lens driving device of claim 2, wherein the lens carrier includes exteriorly four upper fixing structures, four lower fixing structures and at least one fixation lip, the four upper fixing structures being positioned in correspondence to the four lower fixing structures and located circularly to an exterior of the lens carrier for anchoring the upper magnets and the lower magnets, the fixation lips being used to mount the spring member exterior to the lens carrier.

6. The anti-shake lens driving device of claim 5, including four said fixation lips located individually between the corresponding upper fixing structures and the corresponding lower fixing structures.

7. The anti-shake lens driving device of claim 1, wherein the circuit loop further includes four actuators and a control unit, the four actuators connecting individually the four driving coils and electrically coupling the control unit; through the control unit, the four actuators manipulating the four upper and four corresponding lower magnets via the four corresponding driving coils so as to correct tilt angles in the X axis and the Y axis.

8. The anti-shake lens driving device of claim 7, further including:
a first sensor, located in a central empty space of one said driving coil and electrically coupled with the control unit of the circuit loop; and
a second sensor, located in a central empty space of another said driving coil and electrically coupled with the control unit of the circuit loop, the second sensor being neighbored by the first sensor.

9. The anti-shake lens driving device of claim 7, further including:
a first sensor, located in a central empty space of one of said driving coils and electrically coupled with the control unit of the circuit loop; and
a second sensor, located in a central empty space of another one of said driving coils and electrically coupled with the control unit of the circuit loop, the second sensor being neighbored by the first sensor.

10. The anti-shake lens driving device of claim 7, wherein the circuit loop utilizes an external circuit to couple electrically the control unit, and thereby to control current scales and directions at the four driving coils; wherein the external circuit is one of a mobile phone, a tablet computer and a notebook computer.
